(19) United States
(12) Patent Application Publication
(10) Pub. No.: US 2017/0331570 A1
(43) Pub. Date: Nov. 16, 2017

(54) POWER MANAGEMENT SYSTEM, RELAY APPARATUS, AND POWER MANAGEMENT METHOD

(71) Applicant: Kyocera Corporation, Kyoto-shi, Kyoto (JP)

(72) Inventor: Takeshi YAMANE, Yokohama-shi (JP)

(21) Appl. No.: 15/535,342

(22) PCT Filed: Dec. 22, 2015
(86) PCT No.: PCT/JP2015/085828

§ 371 Date: Jun. 12, 2017

(30) Foreign Application Priority Data
Dec. 25, 2014 (JP) 2014-261788
Dec. 25, 2014 (JP) 2014-261794

(51) Int. Cl. H04B 17/40; H04B 7/15; H04Q 9/00

(52) U.S. Cl. CPC H04B 17/40; H04Q 9/00; H04B 7/15; H04Q 2213/13107; H04Q 2209/40

(57) ABSTRACT

A relay apparatus 400 performs control to measure a first signal quality of a radio signal from a smart meter 300 and present the first signal quality to a user. The relay apparatus 400 establishes a radio connection with the smart meter 300 having a radio communication function. The relay apparatus 400 relays communication between the smart meter 300 and the power management apparatus 200.

### TECHNICAL FIELD

The present invention relates to a power management system, a relay apparatus, and a power management method used in a consumer facility where a smart meter is provided.

### BACKGROUND ART

In recent years, an energy management system (EMS) for managing the electric power of an apparatus (equipment) provided in a consumer facility has been drawing attention. In such a power management system, a power management apparatus that manages electric power is provided.

On the other hand, as a meter for measuring electric power supplied from a power grid to a consumer facility, a smart meter having a communication function is known. The smart meter is an apparatus provided by an electric power company or the like, and power information obtained by the smart meter is used for billing for the user or the like.

In addition, the introduction of a mechanism in which the power management apparatus acquires the power information directly from the smart meter by communication between the power management apparatus and the smart meter has been studied (for example, refer to Patent Literature 1).

When near field communication is applied as communication between the smart meter and the power management apparatus, the transmission power of a radio signal from the smart meter may be set to be low in order to reduce interference with the smart meter.

In addition, since a position where the power management apparatus can be installed is sometimes limited, it is not always possible to install the power management apparatus around the smart meter.

Accordingly, when radio communication is applied as communication between the smart meter and the power management apparatus, there is a possibility that communication cannot be appropriately performed between the smart meter and the power management apparatus.

### CITATION LIST

### Patent Literature

Patent Literature 1: Japanese application publication No. 2014-78841

### SUMMARY OF INVENTION

A relay apparatus according to a first aspect comprises: a first radio communication unit that establishes a radio connection with a smart meter having a radio communication function; and a controller that performs control to measure a first signal quality of a radio signal from the smart meter and present the first signal quality to a user. The controller relays communication between the smart meter and a power management apparatus that manages power information obtained by the smart meter.

A power management method according to a second aspect comprises: measuring, by a relay apparatus, a first signal quality of a radio signal from a smart meter having a radio communication function; presenting, by the relay apparatus, the first signal quality to a user; establishing, by the relay apparatus, a radio connection with the smart meter; and relaying, by the relay apparatus, communication between the smart meter and a power management apparatus that manages power information obtained by the smart meter.

A power management system according to a third aspect comprising: a power management apparatus that manages power information; a relay apparatus that establishes a radio connection with a smart meter having a radio communication function and relays communication between the smart meter and the power management apparatus. The relay apparatus performs authentication processing on the smart meter, and establishes a radio connection with the smart meter when the authentication processing is successful.

A relay apparatus according to a fourth aspect comprises a controller that performs authentication processing on a smart meter having a radio communication function and establishes a radio connection with the smart meter when the authentication processing is successful. The relay apparatus relays communication between the smart meter and a power management apparatus.

A power management method according to a fifth aspect comprises: performing, by a relay apparatus, authentication processing on a smart meter having a radio communication function; establishing, by the relay apparatus, a radio connection with the smart meter when the authentication processing is successful; and relaying, by the relay apparatus, communication between the smart meter and a power management apparatus.

### BRIEF DESCRIPTION OF DRAWINGS

FIG. 1 is a block diagram of a power management system according to first to third embodiments.

FIG. 2 is a diagram illustrating the configuration of a consumer facility according to the first and second embodiments.

FIG. 3 is a block diagram of a relay apparatus according to the first and second embodiments.

FIG. 4 is a diagram illustrating an example of the mounting of the relay apparatus according to the first embodiment.

FIG. 5 is a block diagram of a power management apparatus according to the first to third embodiments.

FIG. 6 is a sequence diagram illustrating an example of the operation sequence of the power management system according to the first embodiment.

FIG. 7 is a diagram illustrating an example of the mounting of the relay apparatus according to the second embodiment.

FIG. 8 is a block diagram of a relay apparatus according to the third embodiment.

### DESCRIPTION OF EMBODIMENTS

Hereinafter, embodiments of the present invention will be described with reference to the accompanying diagrams. In addition, in the following description of the diagrams, the same or similar portions are denoted by the same or similar reference numerals.

### First Embodiment

(Configuration of a Power Management System)

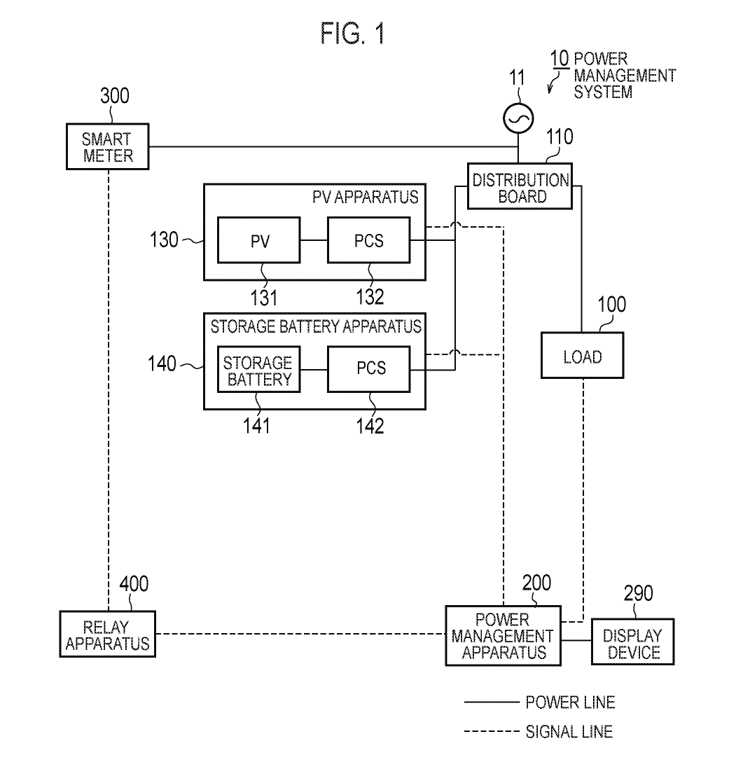

Hereinafter, the configuration of a power management system 10 according to a first embodiment will be described. FIG. 1 is a block diagram of the power management system 10. In FIG. 1, a solid line between blocks indicates a power line, and a broken line between blocks indicates a signal line.

As illustrated in FIG. 1, the power management system 10 has a load 100, a distribution board 110, a photovoltaic (PV) apparatus 130, a storage battery apparatus 140, a power management apparatus 200, a display device 290, a smart meter 300, and a relay apparatus 400.

The load 100 is an apparatus that consumes electric power supplied through the power line. The load 100 may be a single apparatus, or may include a plurality of apparatuses. For example, the load 100 includes a refrigerator, a lighting, an air conditioner, a television, and the like.

The distribution board 110 is an apparatus that performs distribution of electric power and the like. The distribution board 110 is connected to a power grid 11 provided by an electric power company or the like. In addition, the distribution board 110 is connected to the load 100, the PV apparatus 130, and the storage battery apparatus 140 through the power line. In addition, the distribution board 110 may be connected to the power management apparatus 200 and the relay apparatus 400 through the power line.

The PV apparatus 130 is an apparatus that performs power generation, and has a PV 131 and a power conditioning system (PCS) 132. The PV 131 generates electricity in response to the reception of sunlight, and outputs DC power. The PCS 132 converts the DC power output from the PV 131 into AC power, and outputs the AC power through the power line.

The storage battery apparatus 140 is an apparatus that accumulates electric power, and has a storage battery 141 and a PCS 142. The storage battery 141 performs accumulation (charging) of electric power and output (discharging) of electric power. When charging the storage battery 141, the PCS 142 converts AC power input through the power line into DC power, and outputs the DC power to the storage battery 141. When discharging the storage battery 141, the PCS 142 converts the DC power output from the storage battery 141 into AC power, and outputs the AC power through the power line.

The power management apparatus 200 is an apparatus that manages electric power (power information). The power management apparatus 200 is connected to the load 100, the PV apparatus 130, the storage battery apparatus 140, the display device 290, and the relay apparatus 400 through signal lines forming a local area network (LAN). The signal line may be wireless, or may be a cable. In the first embodiment, the signal line between the power management apparatus 200 and the relay apparatus 400 is wireless. The power management apparatus 200 may control the load 100, the PV apparatus 130, the storage battery apparatus 140, and the display device 290. Details of the power management apparatus 200 will be described later.

The display device 290 performs various displays under the control of the power management apparatus 200. The display device 290 may perform communication with the power management apparatus 200 through a wide area network (WAN). The display device 290 may be a television, a tablet terminal, a smartphone, or the like.

The smart meter 300 is a meter apparatus that measures electric power supplied from the power grid 11. The smart meter 300 may measure electric power supplied (reverse flow) from the PV apparatus 130 or the like to the power grid 11. Here, the reverse flow refers to, for example, a flow of electric power flowing from the PV apparatus 130 to the power grid 11 side. Although the single smart meter 300 is illustrated in FIG. 1, a plurality of smart meters 300 may be provided.

The smart meter 300 is, for example, an apparatus provided by an electric power company or the like. The power information obtained by the smart meter 300 is used for billing for the user or the like. The smart meter 300 has a communication function, and is connected to the relay apparatus 400 through the signal line. In the first embodiment, the signal line between the smart meter 300 and the relay apparatus 400 is wireless.

The relay apparatus 400 is an apparatus that relays communication between the power management apparatus 200 and the smart meter 300. As a communication protocol between the power management apparatus 200 and the smart meter 300, for example, ECHONET Lite (registered trademark; the same hereinbelow) is applied. The communication protocol is not limited to this. For example, KNX or SEP 2.0 can be used. Details of the relay apparatus 400 will be described later.

(Configuration of a Consumer Facility)

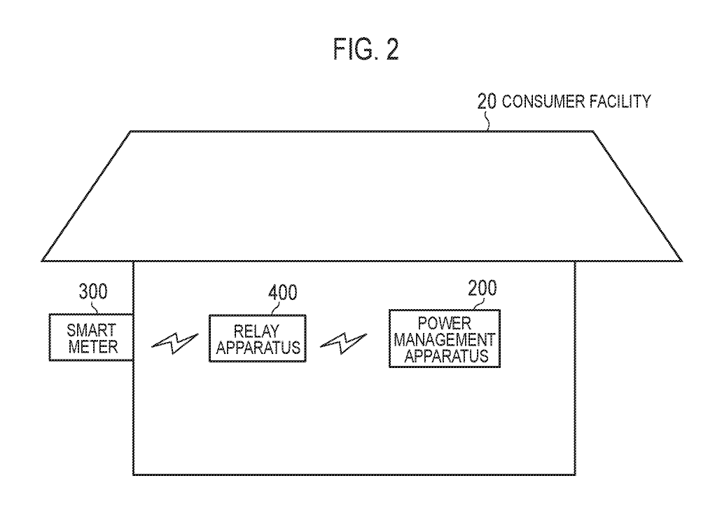

Hereinafter, the configuration of a consumer facility 20 according to the first embodiment will be described. FIG. 2 is a diagram illustrating the configuration of the consumer facility 20. In the first embodiment, a case where the consumer facility 20 is a residence is assumed. The residence may be a detached residence, or may be a residence included in a housing complex (apartment house).

As illustrated in FIG. 2, the power management apparatus 200 and the smart meter 300 are installed in the consumer facility 20. The power management apparatus 200 installed in the residence as the consumer facility 20 may be referred to as a home energy management system (HEMS) or an HEMS controller.

The load 100 and the distribution board 110 illustrated in FIG. 1 are installed in the consumer facility 20. In addition, at least one of the PV apparatus 130 and the storage battery apparatus 140 illustrated in FIG. 1 may be installed in the consumer facility 20.

In such a consumer facility 20, the introduction of a mechanism in which the power management apparatus 200 acquires the power information directly from the smart meter 300 by communication between the power management apparatus 200 and the smart meter 300 has been studied. Such a communication path may be referred to as a “B route”.

As the communication between the smart meter 300 and the power management apparatus 200, cable communication using a power line communication standard, such as G3-PLC (registered trademark), or radio communication using a near field communication standard, such as Wi-SUN (registered trademark; the same hereinbelow), is applied.

In the first embodiment, each of the smart meter 300 and the power management apparatus 200 has a radio communication function based on Wi-SUN. That is, it is possible to establish a radio connection between the smart meter 300 and the power management apparatus 200 and perform radio communication between the smart meter 300 and the power management apparatus 200.

When radio communication is applied as communication between the smart meter 300 and the power management apparatus 200, the transmission power of a radio signal from the smart meter 300 may be set to be low in order to reduce interference with the smart meter 300. This is because, in the B route communication, if it is confirmed that even a small amount of radio signal emitted from the smart meter 300 has entered the consumer facility 20 when installing the smart meter 300, the installation of the smart meter 300 is completed.

In addition, from the viewpoint of securing a power source or the like, a position where the power management apparatus 200 can be installed is sometimes limited. For example, the power management apparatus 200 is installed around the distribution board 110 so as to be able to operate even when the circuit breaker of the distribution board 110 is cut off. Accordingly, it is not always possible to install the power management apparatus 200 around the smart meter 300.

Therefore, when radio communication is applied as communication between the smart meter 300 and the power management apparatus 200, there is a possibility that communication cannot be appropriately performed between the smart meter 300 and the power management apparatus 200. Specifically, when establishing a radio connection directly between the smart meter 300 and the power management apparatus 200, the establishment of a radio connection may fail, or the connection state may become poor later even if the radio connection can be established.

Therefore, in the first embodiment, the relay apparatus 400 establishes a radio connection with the smart meter 300 and a radio connection with the power management apparatus 200, and relays communication between the smart meter 300 and the power management apparatus 200.

Thus, by installing the relay apparatus 400 at an appropriate position, the relay apparatus 400 can establish a good radio connection with the smart meter 300 and a good radio connection with the power management apparatus 200. Accordingly, it is possible to improve the quality of communication between the smart meter 300 and the power management apparatus 200.

The relay apparatus 400 is provided in combination with the power management apparatus 200, for example. That is, the relay apparatus 400 is an apparatus attached to the power management apparatus 200. The relay apparatus 400 may be referred to as a “(radio) adapter”. In the case where the power management apparatus 200 and the relay apparatus 400 are provided in a set as described above, even when the radio connection state changes due to a change in the surrounding environment, it is possible to easily improve the quality of communication by changing the position of the relay apparatus 400. In addition, when the power management apparatus 200 and the relay apparatus 400 are provided in a set, the power management apparatus 200 may not have a function of communication with the smart meter 200.

Alternatively, the relay apparatus 400 may be provided separately from the power management apparatus 200. When the relay apparatus 400 is provided separately from the power management apparatus 200, there is an advantage in such a case that the relay apparatus 400 is not necessary when the power management apparatus 200 is installed but the relay apparatus 400 becomes necessary later. Specifically, for example, there is a case where the relay apparatus 400 is purchased separately when the connection with the smart meter 200 is insufficient with the communication function of the power management apparatus 200 due to a change in the surrounding environment. In this case, it is possible to improve the quality of communication even if the position of the smart meter 200 or the power management apparatus 200 is not changed.

However, since the power information obtained from the smart meter 300 reflects the user's residence situation or the like in the consumer facility 20, it is desirable to ensure the security of the power information. That is, it is desirable to prevent an apparatus different from the power management apparatus 200 from communicating with the smart meter 300.

(Configuration of a Relay Apparatus)

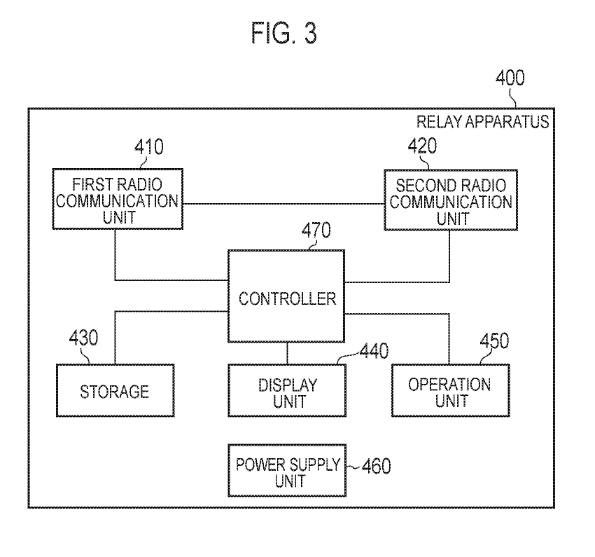

Hereinafter, the configuration of the relay apparatus 400 according to the first embodiment will be described. FIG. 3 is a block diagram of the relay apparatus 400.

As illustrated in FIG. 3, the relay apparatus 400 has a first radio communication unit 410, a second radio communication unit 420, a storage 430, a display unit 440, an operation unit 450, a power supply unit 460, and a controller 470.

The first radio communication unit 410 is a block for establishing a radio connection with the smart meter 300. In the first embodiment, the first radio communication unit 410 is a Wi-SUN radio communication unit conforming to the Wi-SUN communication standard. The Wi-SUN communication standard uses a radio frequency band (for example, 920 MHz band) less than 1 GHz.

The second radio communication unit 420 is a block for establishing a radio connection with the power management apparatus 200. In the first embodiment, the second radio communication unit 420 is a WLAN radio communication unit conforming to a wireless local area network (WLAN) communication standard. The WLAN communication standard refers to IEEE802.11 standards. The WLAN communication standard uses a radio frequency band (for example, 2.4 GHz band or 5 GHz band) higher than 1 GHz.

Thus, in the first embodiment, the communication standard (first radio communication unit 410) used for radio communication between the smart meter 300 and the relay apparatus 400 is different from the communication standard used for radio communication (second radio communication unit 420) between the power management apparatus 200 and the relay apparatus 400. In particular, since the radio frequency band in the first radio communication unit 410 and the radio frequency band in the second radio communication unit 420 are different, radio interference between the first radio communication unit 410 and the second radio communication unit 420 can be made to be difficult to occur.

The storage 430 is a block for storing information and programs used for control in the relay apparatus 400. The storage 430 includes a nonvolatile storage medium and a volatile storage medium.

The storage 430 (nonvolatile storage medium) stores first authentication information, which is used for authentication processing on the power management apparatus 200, in advance. The first authentication information includes an authentication method and an authentication key. The authentication method may be a common key based method, or may be a public key based method. The authentication key is, for example, an ID and a password used in the common key based method or a digital certificate used in the public key based method.

The display unit 440 is a block that performs various displays under the control of the controller 470. The display unit 440 is configured by at least one liquid crystal display (LCD), or at least one light emitting diode (LED), or a combination thereof In the first embodiment, the display unit 440 is configured by a plurality of LEDs.

Instead of the display unit 440 or in addition to the display unit 440, a sound output unit (speaker, buzzer) that emits sound may be provided. In addition, instead of the display unit 440 or in addition to the display unit 440, a vibration generation unit that generates vibration may be provided. The display unit 440, the sound output unit, and the vibration generation unit are used for various presentations to the user.

The operation unit 450 is a block that receives an operation from the user and transmits the operation content to the controller 470. The operation unit 450 is configured by at least one button, or at least one switch, or a combination thereof. When a touch panel display is used as the display unit 440, the operation unit 450 may be configured integrally with the display unit 440.

The power supply unit 460 is a block for supplying electric power to other blocks in the relay apparatus 400. The power supply unit 460 is configured by an AC power supply (AC adaptor), or a battery, or a combination thereof. Ethernet (registered trademark; the same hereinbelow) or a power supply method based on wireless power supply may be applied to the power supply unit 460.

The controller 470 is a block that performs various kinds of control by executing a program stored in the storage 430. The controller 470 is configured by at least one processor. In the first embodiment, the controller 470 controls the first radio communication unit 410, the second radio communication unit 420, and the display unit 440.

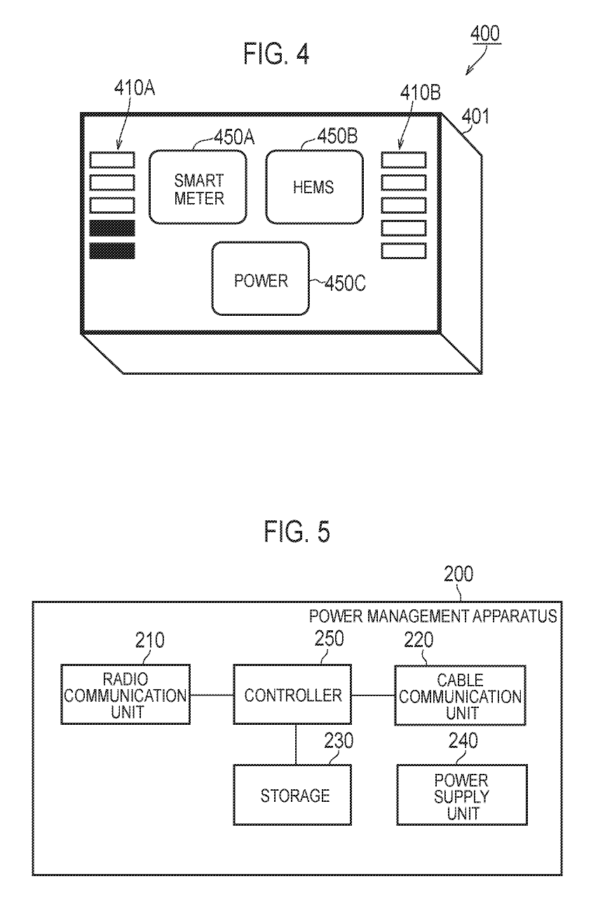

In the first embodiment, after electric power is supplied to the relay apparatus 400, the controller 470 automatically starts searching for a signal emitted from the power management apparatus 200. “Electric power is supplied to the relay apparatus 400” indicates that a power switch 450C (refer to FIG. 4) forming the operation unit 450 is turned on. In a case where the relay apparatus 400 does not have the power switch 450C, “electric power is supplied to the relay apparatus 400” may be “power supply unit 460 is connected to the outlet”. In addition, the “signal emitted from the power management apparatus 200” is a WLAN radio signal, such as a beacon signal or a probe response signal.

Thus, by automatically starting searching for a signal emitted from the power management apparatus 200 after electric power is supplied to the relay apparatus 400, a part of the sequence of connection between the relay apparatus 400 and the power management apparatus 200 is automated. As a result, it is possible to improve the convenience of the user.

When a signal emitted from the power management apparatus 200 is detected by searching, the controller 470 performs authentication processing (hereinafter, referred to as “first authentication processing”) on the power management apparatus 200. In the first embodiment, the controller 470 performs the first authentication processing when the signal emitted from the power management apparatus 200 is detected by searching and a connection button 450B (refer to FIG. 4) forming the operation unit 450 is pressed. When the relay apparatus 400 does not have the connection button 450B, the controller 470 may perform the first authentication processing immediately after the signal emitted from the power management apparatus 200 is detected by searching.

The controller 470 performs the first authentication processing using the first authentication information stored in advance in the storage 430. The controller 470 establishes a radio connection with the power management apparatus 200 when the authentication processing on the power management apparatus 200 is successful.

Here, the first authentication processing may include processing for acquiring authentication information from the power management apparatus 200 and checking the validity of the power management apparatus 200 by comparing the acquired authentication information with the first authentication information. The first authentication processing may also include processing for notifying the power management apparatus 200 of the first authentication information and checking the validity of the relay apparatus 400 by performing comparison of the first authentication information in the power management apparatus 200.

Thus, by performing the authentication processing on the power management apparatus 200 using the first authentication information included in advance in the relay apparatus 400, the relay apparatus 400 (second radio communication unit 420) can establish a radio connection only with the legitimate power management apparatus 200. In other words, a third party's apparatus cannot establish a radio connection with the relay apparatus 400 since the third party's apparatus fails in the first authentication processing.

In the first embodiment, the power management apparatus 200 stores second authentication information, which is used for authentication processing on the smart meter 300, in advance. Details of the second authentication information will be described later.

The controller 470 acquires the second authentication information from the power management apparatus 200 after establishing a radio connection with the power management apparatus 200. In addition, the controller 470 automatically starts searching for a signal emitted from the smart meter 300. The “signal emitted from the smart meter 300” is a Wi-SUN radio signal. Searching for a signal emitted from the smart meter 300 may be started before acquiring the second authentication information from the power management apparatus 200. For example, the controller 470 may automatically start searching for a signal emitted from the smart meter 300 after electric power is supplied to the relay apparatus 400.

Thus, by automatically starting searching for a signal emitted from the smart meter 300, a part of the sequence of connection between the relay apparatus 400 and the smart meter 300 is automated. As a result, it is possible to improve the convenience of the user.

The controller 470 performs authentication processing (hereinafter, referred to as “second authentication processing”) on the smart meter 300 using the second authentication information. The controller 470 performs the second authentication processing when the second authentication information is acquired and a connection button 450A (refer to FIG. 4) forming the operation unit 450 is pressed. When the relay apparatus 400 does not have the connection button 450A, the controller 470 may perform the second authentication processing immediately after acquiring the second authentication information.

The controller 470 establishes a radio connection with the smart meter 300 when the second authentication processing is successful. Here, the second authentication processing may include processing for acquiring authentication information from the smart meter 300 and checking the validity of the smart meter 300 by comparing the acquired authentication information with the second authentication information. The second authentication processing may also include processing for notifying the smart meter 300 of the second authentication information and checking the validity of the relay apparatus 400 by performing comparison of the second authentication information in the smart meter 300.

Thus, by performing the authentication processing on the smart meter 300 using the second authentication information acquired from the power management apparatus 200, the relay apparatus 400 (first radio communication unit 410) can establish a radio connection only with the legitimate smart meter 300.

In this manner, when a radio connection with the smart meter 300 and a radio connection with the power management apparatus 200 are established, the controller 470 performs control to relay communication between the smart meter 300 and the power management apparatus 200. As described above, the relay apparatus 400 establishes a radio connection only with the legitimate power management apparatus 200 and the legitimate smart meter 300, so that one-to-one communication is guaranteed in the communication between the power management apparatus 200 and the smart meter 300. That is, it is possible to make it difficult for an apparatus different from the power management apparatus 200 to communicate with the smart meter 300 through the relay apparatus 400. Therefore, it is possible to ensure the security of the power information acquired from the smart meter 300.

(User Interface of a Relay Apparatus)

Hereinafter, a user interface of the relay apparatus 400 according to the first embodiment will be described.

The controller 470 measures the signal quality (hereinafter, referred to as “first signal quality”) of the radio signal (Wi-SUN radio signal) from the smart meter 300. The signal quality is, for example, a reception power level, such as RSSI, or a reception quality level, such as SNR. The controller 470 performs control to present the first signal quality to the user.

Here, “present to the user” refers to display using the display unit 440, sound output using a sound output unit, generation of vibration using a vibration generation unit, or a combination thereof In the first embodiment, it is assumed that the presentation is display using the display unit 440.

By presenting the first signal quality to the user as described above, the user can grasp the first signal quality.

The controller 470 performs control to present the first signal quality to the user in a state in which the radio connection with the smart meter 300 is not established. Accordingly, since the user can install the relay apparatus 400 at a position where the first signal quality is good, the relay apparatus 400 can establish a good radio connection with the smart meter 300.

In addition, the controller 470 performs control to further measure the radio quality (hereinafter, referred to as “second signal quality”) of a radio signal (WLAN radio signal) from the power management apparatus 200 and present the first signal quality and the second signal quality to the user.

By presenting not only the first signal quality but also the second signal quality to the user as described above, the user can grasp the second signal quality.

The controller 470 performs control to present the second signal quality to the user in a state in which the radio connection with the power management apparatus 200 is not established. Accordingly, since the user can install the relay apparatus 400 at a position where the second signal quality is good, the relay apparatus 400 can establish a good radio connection with the power management apparatus 200.

As a result, the relay apparatus 400 can establish a good radio connection with the smart meter 300 and a good radio connection with the power management apparatus 200. Therefore, it is possible to improve the quality of communication between the smart meter 300 and the power management apparatus 200.

FIG. 4 is a diagram illustrating an example of the mounting of the relay apparatus 400 according to the first embodiment.

As illustrated in FIG. 4, the relay apparatus 400 has a rectangular parallelepiped housing 401. The first radio communication unit 410, the second radio communication unit 420, the storage 430, the power supply unit 460, and the controller 470 illustrated in FIG. 3 are housed in the housing 401.

The display unit 440 and the operation unit 450 are disposed on one surface of the housing 401. By disposing the display unit 440 and the operation unit 450 on the same surface of the housing 401 as described above, it is possible to enhance the visibility and operability of the user.

The display unit 440 has a first display unit 410A for displaying the first signal quality and a second display unit 410B for displaying the second signal quality. In the first embodiment, each of the first display unit 410A and the second display unit 410B is configured by a plurality of LEDs. The controller 470 turns on LEDs of the number corresponding to the first signal quality in the first display unit 410A. In addition, the controller 470 turns on LEDs of the number corresponding to the second signal quality in the second display unit 410B.

It is preferable that the display mode of the first signal quality in the first display unit 410A is different from the display mode of the second signal quality in the second display unit 410B. For example, the display color of the LED in the first display unit 410A is different from the display color of the LED in the second display unit 410B. Alternatively, the display shape of the LED in the first display unit 410A is different from the display shape of the LED in the second display unit 410B. As a result, it is possible to improve the visibility of the user.

In the first embodiment, the operation unit 450 has a first operation unit (connection button 450A) that receives from the user a first connection operation instructing to establish a radio connection with the smart meter 300 and a second operation unit (connection button 450B) that receives from the user a second connection operation instructing to establish a radio connection with the power management apparatus 200.

When the first operation unit (connection button 450A) receives the first connection operation, the controller 470 performs control to establish a radio connection with the smart meter 300. As a result, the user can establish a radio connection with the smart meter 300 after confirming the first signal quality displayed on the first display unit 410A and installing the relay apparatus 400 at a position where the first signal quality is good.

When the radio connection with the smart meter 300 is established, the controller 470 performs control to present to the user a notification indicating that the radio connection with the smart meter 300 has been established. As a result, the user can grasp that the relay apparatus 400 has established the radio connection with the smart meter 300.

For example, the controller 470 presents a notification, which indicates that the radio connection with the smart meter 300 has been established, to the user by changing the first display unit 410A to a special display mode. The “special display mode” refers to a display mode, such as turning on and off the LED. Alternatively, the controller 470 may present the notification to the user by means other than the display unit 440 (a sound output unit, a vibration generation unit, or the like).

After the radio connection with the smart meter 300 is established, the controller 470 turns off the LED of the first display unit 410A. As a result, power saving of the relay apparatus 400 can be achieved. Alternatively, the controller 470 may not turn off the LED of the first display unit 410A. By keeping the LED of the first display unit 410A in a lit state, it is possible to easily check the state of the current communication quality.

In addition, when the second operation unit (connection button 450B) receives the second connection operation, the controller 470 performs control to establish a radio connection with the power management apparatus 200. As a result, the user can establish a radio connection with the power management apparatus 200 after confirming the second signal quality displayed on the second display unit 410B and installing the relay apparatus 400 at a position where the second signal quality is good.

When the radio connection with the power management apparatus 200 is established, the controller 470 performs control to present to the user a notification indicating that the radio connection with the power management apparatus 200 has been established. As a result, the user can grasp that the relay apparatus 400 has established the radio connection with the power management apparatus 200.

For example, the controller 470 presents a notification, which indicates that the radio connection with the power management apparatus 200 has been established, to the user by changing the second display unit 410B to a special display mode. Alternatively, the controller 470 may present the notification to the user by means other than the display unit 440 (a sound output unit, a vibration generation unit, or the like).

The controller 470 may turn off the LED of the second display unit 410B after a predetermined time has passed from the establishment of the radio connection with the power management apparatus 200. As a result, power saving of the relay apparatus 400 can be achieved. In addition, the predetermined time can be set to be, for example, 1 minute or more and 10 minutes or less. Alternatively, the controller 470 may not turn off the LED of the second display unit 410B. By keeping the LED of the second display unit 410B in a lit state, it is possible to easily check the state of the current communication quality.

In addition, when the state of connection with the smart meter 300 deteriorates after the radio connection with the smart meter 300 is established, the controller 470 may perform control to present to the user a warning indicating that the state of connection with the smart meter 300 has deteriorated. “Deterioration of the connection state” indicates that the signal quality is below the threshold value or that the radio connection has been disconnected. As a warning presentation, the first display unit 410A may be changed to a special display mode, or a warning may be issued by means other than the display unit 440 (a sound output unit, a vibration generation unit, or the like).

In addition, when the state of connection with the power management apparatus 200 deteriorates after the radio connection with the power management apparatus 200 is established, the controller 470 may perform control to present to the user a warning indicating that the state of connection with the power management apparatus 200 has deteriorated. As a warning presentation, the second display unit 410B may be changed to a special display mode, or a warning may be issued by means other than the display unit 440 (a sound output unit, a vibration generation unit, or the like).

By presenting such a warning to the user, the user can take measures, such as changing the installation position of the relay apparatus 400.

(Configuration of a Power Management Apparatus)

Hereinafter, the configuration of the power management apparatus 200 according to the first embodiment will be described. FIG. 5 is a block diagram of the power management apparatus 200.

As illustrated in FIG. 5, the power management apparatus 200 has a radio communication unit 210, a cable communication unit 220, a storage 230, a power supply unit 240, and a controller 250.

The radio communication unit 210 is a block for establishing a radio connection with the relay apparatus 400. In the first embodiment, the radio communication unit 210 is a WLAN radio communication unit conforming to the WLAN communication standard. The power management apparatus 200 may have a Wi-SUN radio communication unit in addition to the radio communication unit 210 (WLAN radio communication unit).

The cable communication unit 220 is a block used for cable communication with an apparatus in the consumer facility 20. In the first embodiment, the cable communication unit 220 may not be necessary.

The storage 230 is a block for storing information and programs used for control in the power management apparatus 200. The storage 230 includes a nonvolatile storage medium and a volatile storage medium.

The storage 230 (nonvolatile storage medium) stores second authentication information, which is used for authentication processing on the smart meter 300, in advance. The second authentication information includes an authentication method and an authentication key.

The second authentication information is the same authentication information as authentication information used for authentication processing when the power management apparatus 200 establishes a radio connection with the smart meter 300. Alternatively, the second authentication information may be authentication information different from authentication information used for authentication processing when the power management apparatus 200 establishes a radio connection with the smart meter 300.

The power supply unit 240 is a block for supplying electric power to other blocks in the power management apparatus 200. The power supply unit 240 is configured by an AC power supply (AC adaptor), or a battery, or a combination thereof.

The controller 250 is a block that performs various kinds of control by executing a program stored in the storage 230. The controller 250 is configured by at least one processor. The controller 250 controls the radio communication unit 210 and the cable communication unit 220.

The controller 250 performs authentication processing (first authentication processing) on the relay apparatus 400, and establishes a radio connection with the relay apparatus 400 when the authentication processing on the relay apparatus 400 is successful. In addition, the controller 250 notifies the relay apparatus 400 of the second authentication information after establishing a radio connection with the relay apparatus 400.

(Operation Sequence)

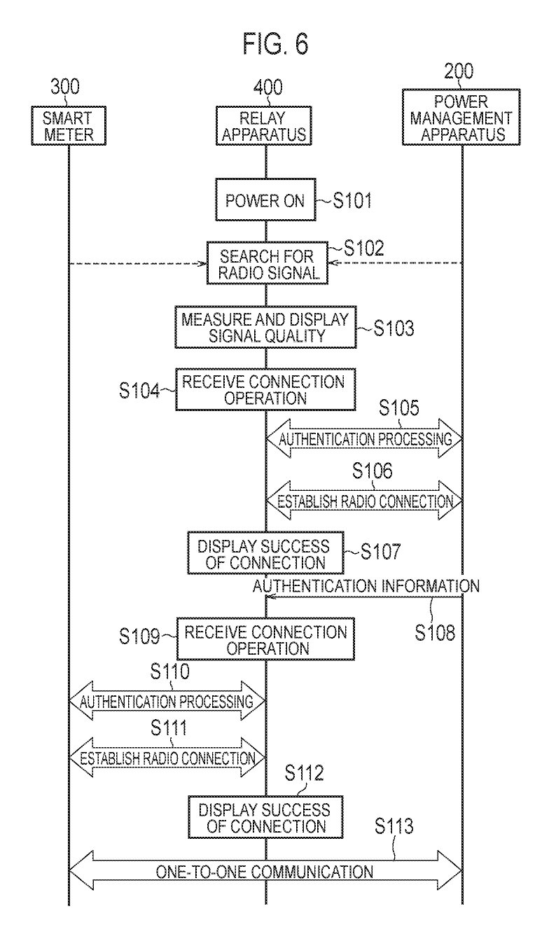

Hereinafter, an example of the operation sequence of the power management system 10 according to the first embodiment will be described. FIG. 6 is an operation sequence diagram of the power management system 10.

As illustrated in FIG. 6, in step S101, when the user turns on the power switch 450C, electric power is supplied to the relay apparatus 400.

In step S102, the relay apparatus 400 automatically starts searching for a radio signal emitted from the smart meter 300. In addition, the relay apparatus 400 automatically starts searching for a radio signal emitted from the power management apparatus 200.

In step S103, the relay apparatus 400 measures the first signal quality of the radio signal from the smart meter 300, and displays the first signal quality. In addition, the relay apparatus 400 measures the second signal quality of the radio signal from the power management apparatus 200, and displays the second signal quality.

In step S104, the relay apparatus 400 receives a connection operation (second connection operation), which instructs to establish a radio connection with the power management apparatus 200, from the user. However, step S104 is not essential. That is, the relay apparatus 400 may try to establish a radio connection with the power management apparatus 200 even if there is no connection operation of the user. Then, the relay apparatus 400 may shift to a state waiting for the user's connection operation only when the establishment of a radio connection with the power management apparatus 200 fails. Therefore, it is possible to further automate the connection sequence.

In step S105, the relay apparatus 400 performs authentication processing (first authentication processing) on the power management apparatus 200 using the first authentication information included in advance in the relay apparatus 400.

In step S106, the relay apparatus 400 establishes a radio connection with the power management apparatus 200 when authentication processing on the power management apparatus 200 is successful. Here, the relay apparatus 400 may exchange keys with the power management apparatus 200. Specifically, the relay apparatus 400 exchanges an encryption key, which is applied to radio communication with the power management apparatus 200, with the power management apparatus 200.

In step S107, the relay apparatus 400 presents a notification, which indicates that the radio connection with the smart meter 300 has been established, to the user.

In step S108, the power management apparatus 200 notifies the relay apparatus 400 of the second authentication information. The relay apparatus 400 acquires the second authentication processing.

In step S109, the relay apparatus 400 receives a connection operation (first connection operation), which instructs to establish a radio connection with the smart meter 300, from the user. However, step S109 is not essential. That is, the relay apparatus 400 may try to establish a radio connection with the smart meter 300 even if there is no connection operation of the user. Then, the relay apparatus 400 may shift to a state waiting for the user's connection operation only when the establishment of a radio connection with the smart meter 300 fails. Therefore, it is possible to further automate the connection sequence.

In step S110, the relay apparatus 400 performs authentication processing (second authentication processing) on the smart meter 300 using the second authentication information acquired from the power management apparatus 200.

In step S111, the relay apparatus 400 establishes a radio connection with the smart meter 300 when authentication processing on the smart meter 300 is successful. Here, the relay apparatus 400 may exchange keys with the smart meter 300. Specifically, the relay apparatus 400 exchanges an encryption key, which is applied to radio communication with the smart meter 300, with the smart meter 300.

In step S112, the relay apparatus 400 presents a notification, which indicates that the radio connection with the smart meter 300 has been established, to the user. However, steps S104 and S109 may be combined into one step. Specifically, step S104 may be omitted, and the user may be notified in step 5109 of the fact that the radio connection with the power management apparatus 200 has been established and the radio connection with the smart meter 300 has been established.

In step S113, the relay apparatus 400 relays communication between the smart meter 300 and the power management apparatus 200 (one-to-one communication). As a communication protocol between the smart meter 300 and the power management apparatus 200, ECHONET Lite is applied.

### Summary of the First Embodiment

As described above, according to the first embodiment, since one-to-one communication between the power management apparatus 200 and the smart meter 300 is guaranteed, it is possible to ensure the security of power information obtained from the smart meter 300. In addition, by automating the connection sequence, it is possible to improve the convenience of the user at the time of installing the relay apparatus 400.

According to the first embodiment, the user can grasp the signal quality on the power management apparatus 200 side and the signal quality on the smart meter 300 side based on the display of the relay apparatus 400. As a result, since the relay apparatus 400 can be installed at an appropriate position, it is possible to improve the quality of communication between the smart meter 300 and the power management apparatus 200.

### MODIFICATION EXAMPLE OF THE FIRST EMBODIMENT

In a modification example of the first embodiment, the power management apparatus 200 performs control to measure the signal quality of the radio signal (WLAN radio signal) from the relay apparatus 400 and present the signal quality to the user. The power management apparatus 200 may perform the presentation in a state in which a radio connection with the relay apparatus 400 is not established, or may perform the presentation after the radio connection with the relay apparatus 400 is established. For example, the power management apparatus 200 displays the measured signal quality on the display device 290. As a result, the user can also grasp the signal quality of the radio signal received from the relay apparatus 400 by the power management apparatus 200.

In addition, in the modification example of the first embodiment, when the state of connection with the relay apparatus 400 deteriorates after the radio connection with the relay apparatus 400 is established, the power management apparatus 200 performs control to present to the user a warning indicating that the state of connection with the relay apparatus 400 has deteriorated. For example, the power management apparatus 200 displays the warning on the display device 290. As a result, the user can grasp that the state of connection between the power management apparatus 200 and the relay apparatus 400 has deteriorated.

### Second Embodiment

Hereinafter, differences between the first embodiment and a second embodiment will be described.

A relay apparatus 400 according to the second embodiment does not have a first operation unit (connection button 450A) that receives from the user a first connection operation instructing to establish a radio connection with the smart meter 300 and a second operation unit (connection button 450B) that receives from the user a second connection operation instructing to establish a radio connection with the power management apparatus 200.

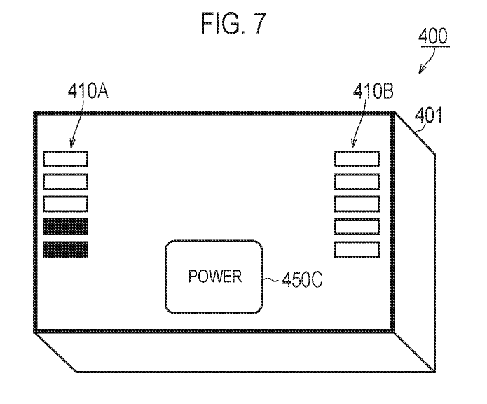

FIG. 7 is a diagram illustrating an example of the mounting of the relay apparatus 400 according to the second embodiment.

As illustrated in FIG. 7, the relay apparatus 400 does not have the connection button 450A and the connection button 450B, but has a power switch 450C as the operation unit 450. In the second embodiment, the power switch 450C also has the functions of the connection button 450A and the connection button 450B.

In the second embodiment, when the power switch 450C is turned on, the controller 470 regards that a connection operation instructing to establish both a radio connection with the smart meter 300 and a radio connection with the power management apparatus 200 has been received from the user. Then, the controller 470 performs control to establish both the radio connection with the smart meter 300 and the radio connection with the power management apparatus 200. Specifically, in the second embodiment, steps S104 and S109 illustrated in FIG. 6 are always omitted.

Alternatively, when the relay apparatus 400 does not have the power switch 450C, a collective connection button may be provided as the operation unit 450. The collective connection button receives a connection operation (collective connection operation), which instructs to establish both the radio connection with the smart meter 300 and the radio connection with the power management apparatus 200, from the user. Then, the controller 470 performs control to establish both the radio connection with the smart meter 300 and the radio connection with the power management apparatus 200 according to the collective connection operation.

As described above, according to the second embodiment, by automating the connection sequence, it is possible to improve the convenience of the user at the time of installing the relay apparatus 400.

### Third Embodiment

Hereinafter, differences between the first embodiment and a third embodiment will be described.

In the third embodiment, the connection between the relay apparatus 400 and the power management apparatus 200 is not a radio connection but a cable connection.

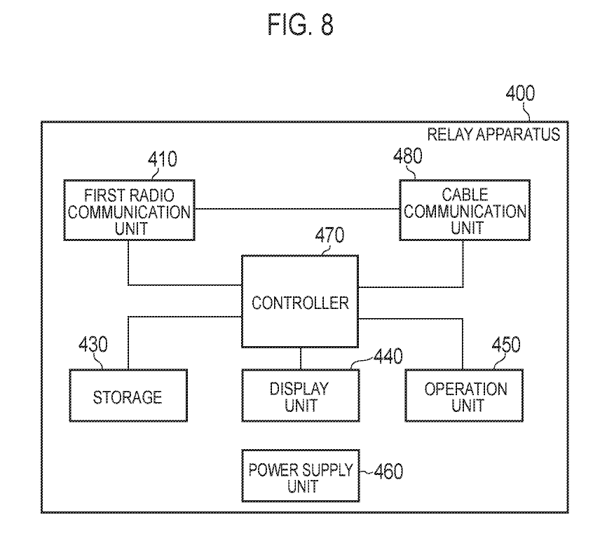

FIG. 8 is a block diagram of the relay apparatus 400 according to the third embodiment. As illustrated in FIG. 8, the relay apparatus 400 has a cable communication unit 480 instead of the second radio communication unit 420 illustrated in FIG. 3. The cable communication unit 480 is a block that performs cable communication with the cable communication unit 220 of the power management apparatus 200.

For example, the cable communication unit 480 is connected to the cable communication unit 220 of the power management apparatus 200 through a physical cable. In this case, the second display unit 410B and the connection button 450B illustrated in FIG. 4 can be made unnecessary. In addition, the connection sequence between the relay apparatus 400 and the power management apparatus 200 can be made unnecessary.

In the present embodiment, the case has been described in which the connection between the relay apparatus 400 and the power management apparatus 200 is a cable connection. However, the connection between the relay apparatus 400 and the smart meter 300 may be a cable connection.

### Other Embodiments

In the first and second embodiments described above, the case is assumed in which the communication standard used for radio communication between the smart meter 300 and the relay apparatus 400 is different from the communication standard used for radio communication between the power management apparatus 200 and the relay apparatus 400. However, the same communication standard (for example, Wi-SUN communication standard) may be applied between the smart meter 300 and the relay apparatus 400 and between the power management apparatus 200 and the relay apparatus 400.

In each of the embodiments described above, an example has been described in which the communication protocol between the power management apparatus 200 and the smart meter 300 is ECHONET Lite. However, a different communication protocol from ECHONET Lite may be applied.

In each of the embodiments described above, an example has been described in which the consumer facility 20 is a residence and the power management apparatus 200 is an HEMS. However, the consumer facility 20 may be a facility (for example, a building, a factory, a store, and the like) different from the residence. That is, the power management apparatus 200 may be a building energy management system (BEMS), a factory energy management system (FEMS), a store energy management system (SEMS), or the like.

In each of the embodiments described above, after establishing radio communication between the power management apparatus 200 and the smart meter 300, the relay apparatus 400 may transmit to the power management apparatus 200 the fact that the radio connection has been established. By transmitting to the power management apparatus 200 the fact that the radio connection has been established as described above, the power management apparatus 200 can make a display, which shows that the radio connection has been established, on the display device. Therefore, it is possible to improve the convenience of the consumer. In addition, when the radio connection is interrupted, the fact can be displayed on the display device.

While the embodiments of the present invention have been described above, it is apparent to those skilled in the art that the present invention is not limited to the embodiments described above, and the present invention can be implemented as modifications and changes without departing from the spirit and scope of the present invention as defined by the description of the appended claims.

In addition, priority is claimed on Japanese patent application No. 2014-261794 filed on Dec. 25, 2014 and Japanese patent application No. 2014-261788 filed on Dec. 25, 2014, the content of which is incorporated herein by reference.

### INDUSTRIAL APPLICABILITY

According to the present invention, it is possible to provide a power management system, a relay apparatus, and a power management method capable of appropriately performing communication between a smart meter and a power management apparatus.

1. A relay apparatus, comprising:
a first radio communication unit that establishes a radio connection with a smart meter having a radio communication function; and
a controller that performs control to measure a first signal quality of a radio signal from the smart meter and present the first signal quality to a user, wherein
the controller relays communication between the smart meter and a power management apparatus that manages power information obtained by the smart meter.

2. The relay apparatus according to claim 1, wherein
the controller performs control to present the first signal quality to the user in a state in which a radio connection with the smart meter is not established.

3. The relay apparatus according to claim 1, further comprising:
a first operation unit that receives from the user a first connection operation instructing to establish a radio connection with the smart meter, wherein
the controller performs control to establish a radio connection with the smart meter when the first operation unit receives the first connection operation.

4. The relay apparatus according to claim 1, wherein
when the radio connection with the smart meter is established, the controller performs control to present a notification, which indicates that the radio connection with the smart meter has been established, to the user.

5. The relay apparatus according to claim 1, wherein
when a state of connection with the smart meter deteriorates after the radio connection with the smart meter is established, the controller performs control to present a warning, which indicates that the state of connection with the smart meter has deteriorated, to the user.

6. The relay apparatus according to claim 1, further comprising:
a second radio communication unit that establishes a radio connection with the power management apparatus, wherein
the controller performs control to further measure a second signal quality of a radio signal from the power management apparatus and present the first signal quality and the second signal quality to the user.

7. The relay apparatus according to claim 6, wherein
the controller performs control to present the second signal quality to the user in a state in which a radio connection with the power management apparatus is not established.

8. The relay apparatus according to claim 7, further comprising:
a second operation unit that receives from the user a second connection operation instructing to establish a radio connection with the power management apparatus, wherein
the controller performs control to establish a radio connection with the power management apparatus when the second operation unit receives the second connection operation.

9. The relay apparatus according to claim 7, further comprising:
an operation unit that receives from the user a connection operation instructing to establish both a radio connection with the smart meter and a radio connection with the power management apparatus, wherein
the controller performs control to establish a radio connection with the smart meter and a radio connection with the power management apparatus when the operation unit receives the connection operation.

10. The relay apparatus according to claim 7, wherein
when the radio connection with the power management apparatus is established, the controller performs control to present a notification, which indicates that the radio connection with the power management apparatus has been established, to the user.

11. The relay apparatus according to claim 6, wherein
when a state of connection with the power management apparatus deteriorates after the radio connection with the power management apparatus is established, the controller performs control to present a warning, which indicates that the state of connection with the power management apparatus has deteriorated, to the user.

12. A power management method, comprising:
measuring, by a relay apparatus, a first signal quality of a radio signal from a smart meter having a radio communication function;
presenting, by the relay apparatus, the first signal quality to a user;
establishing, by the relay apparatus, a radio connection with the smart meter; and
relaying, by the relay apparatus, communication between the smart meter and a power management apparatus that manages power information obtained by the smart meter.

13. The relay apparatus according to claim 1, wherein
the controller performs authentication processing on the smart meter, and establishes a radio connection with the smart meter when the authentication processing is successful.

14. The relay apparatus according to claim 13, wherein
the controller performs authentication processing on the power management apparatus, and establishes a radio connection with the power management apparatus when the authentication processing is successful.

15. The relay apparatus according to claim 13, wherein
the controller performs authentication processing on the power management apparatus using first authentication information stored in advance.

16. The relay apparatus according to claim 13, wherein
the relay apparatus automatically starts searching for a signal emitted from the power management apparatus after electric power is supplied to the relay apparatus, and performs authentication processing on the power management apparatus when the signal emitted from the power management apparatus is detected by the searching.

17. The relay apparatus according to claim 13, wherein
the power management apparatus stores second authentication information, which is used for authentication processing on the smart meter, in advance, and
the controller acquires the second authentication information from the power management apparatus after establishing a radio connection with the power management apparatus, and performs authentication processing on the smart meter using the second authentication information.

18. The relay apparatus according to claim 17, wherein
the second authentication information is the same authentication information as authentication information used for authentication processing when establishing a radio connection with the smart meter.

19. The relay apparatus according to claim 17, wherein
the second authentication information is authentication information different from authentication information used for authentication processing when establishing a radio connection with the smart meter.

20. The relay apparatus according to claim 14, wherein
a communication standard used for radio communication with the smart meter is different from a communication standard used for radio communication with the power management apparatus.

21. The relay apparatus according to claim 13, wherein
control to measure a signal quality of a radio signal from the power management apparatus and present the signal quality to a user is performed.

22. The relay apparatus according to claim 13, wherein
when a state of connection with the power management apparatus deteriorates, control to present a warning, which indicates that the connection state has deteriorated, to a user is performed.

23. The relay apparatus according to claim 1, wherein
after establishing a radio connection with at least one of the power management apparatus and the smart meter, the controller transmits to the power management apparatus a fact that the radio connection has been established.

24.-25. (canceled)
